(19) United States
(12) Patent Application Publication
(10) Pub. No.: US 2006/0083889 A1
(43) Pub. Date: Apr. 20, 2006

(54) Laminated duct board

(76) Inventor: Douglass Stuart Schuckers, Albrightsville, PA (US)

Correspondence Address: DUANE MORRIS, LLP;IP DEPARTMENT, 30 SOUTH 17TH STREET, PHILADELPHIA, PA, 19103-4196, US

(21) Appl. No.: 10/969,384

(22) Filed: Oct. 19, 2004

(51) Int. Cl. B32B 3/00; B32B 3/14; B32B 3/02

(52) U.S. Cl. 428/58; 428/57; 428/60; 428/77; 428/78; 428/79

(57) ABSTRACT

A duct board product includes a fibrous duct board having at least one set of opposing edges, a second board of insulating material having at least one set of opposing edges, and an adhesive material. The fibrous duct board is laminated to the second board of insulating material by the adhesive material. At least one edge of one set of opposing edges of the fibrous duct board is offset from at least one respective edge of one set of opposing edges of the second board of insulating material to form at least one shiplap edge.

### FIELD OF THE INVENTION

The invention relates generally to the field of building material products and, in particular, to insulated air ducts and methods for making the same.

### BACKGROUND OF THE INVENTION

Ducts and conduits are used to convey air in building heating, ventilation and air conditioning (HVAC) systems. Rigid fibrous glass duct board systems are manufactured from resin bonded inorganic glass fibers and are used to conserve heating and cooling energy and to control duct-borne noise in commercial, institutional, or residential HVAC systems. The popularity of such duct systems has increased significantly during the past few decades with millions of feet of fibrous glass duct work presently in operation in schools, shopping centers, office buildings, apartments, and residences throughout the United States. When compared to a traditional metal duct system, the use of a fibrous glass duct system can improve the overall quality of the indoor environment through its efficient thermal and acoustical properties, and its ability to virtually eliminate condensation problems. Moreover, a fiber glass duct system is generally less expensive to install than an insulated and sealed wrapped or lined sheet metal system because of faster and easier fabrication and installation. Fiber glass duct systems also weigh less and therefore easier to handle as compared to sheet metal systems.

Generally, a fiberglass duct board system is made up of four foot sections which are fabricated from 1 inch, 1½ inch or 2 inch thick flat fibrous glass duct board sheets. Typically, one major surface of the duct board sheet includes a facing which serves as a finish and an air barrier/vapor retarder. The facing is typically a metal foil or a reinforced foil laminate. This faced surface ultimately serves as the outside surface of the assembled duct system.

One advantage of fiber glass duct board systems is that the duct has thermal insulation and does not require external insulation like sheet metal ducts require. However, under many current design standards, 2 inch thick duct board is necessary to meet the required energy code, which requires duct system R-values of at least 8.0. (The thermal resistance (R-value) of 2 inch fiber glass duct board is 8.7 Btu/h·ft²·° F. at 75° F. For 1½ inch fiber glass duct board, the R-value is 6.5, and for 1 inch fiber glass the duct board the R-value is 4.3.)

The duct board sections are fabricated by folding the duct board sheets into square, rectangular, or other multi-sided duct sections for use in use in both residential and commercial heating, ventilating, and air conditioning duct systems. Grooves are cut into the board where the board will be folded and thereafter is formed into duct sections, which are then stapled or taped and sealed at the longitudinal joint. Sections may be joined in the same way. Frequently, the duct boards are supplied with factory molded male and female shiplap transverse edges and/or longitudinal edges to ensure a tight and strong fabricated joint between edges in an individual duct section and/or between adjoining duct sections. Typically, duct board sheets are fabricated into individual sections using specially designed hand tools or grooving and closure machines to form the grooves and potentially also the longitudinal shiplap. Correct tool blade settings are very important in assuring accurate fabrication, tight joints, and an air-tight duct system that performs to specifications. Several different systems or tools have been developed to form the male and female shiplap edges.

U.S. Pat. No. 4,226,662 to McCort discloses a method and apparatus for treating a fibrous board, wherein a portion of the board is cut away at the edges to form a kerfed shiplap edge to allow the fibrous board, once formed into a duct board section, to sealingly connect with successive duct board sections. The cut edges are sealed with a liquid to prevent damage to the edges that often occurs during packaging, shipping and installing. Use of this method may increase the cost of fabricating the fibrous board by adding an additional step and materials to the fabrication process.

U.S. Pat. No. 4,983,081 to Cunningham, Jr. discloses a shiplap groove cutting tool for hand cutting grooves and female shiplap edges into duct board to allow the duct board to be folded into a duct section. To form the female shiplap edge, a standard number 1 tool is moved along the side edge of the duct board with a guide flange of the tool against the side edge of the board and a sled of the tool running on the top the board to permit the blades of the tool to cut a notch to form the female shiplap edge. The cutting of the shiplap edge often results in fiber erosion at the area of the cut, which in turn may lead to the presence of the fibers within the duct system.

U.S. Pat. No. 4,490,927 to Kissell discloses an apparatus for curing fibrous mineral insulation material including an oven and conveyor means for carrying the uncured mineral insulation material through the oven. The conveyor means may include flights adapted with side guides. The side guides can be adapted to mold desired configurations such as shiplap edges into the edges of the insulation product. Often molding processes, such as the one disclosed in the Kissell patent, fail to provide truly square corners needed for proper sealing, in addition to requiring oven block changes.

What is needed is an improved insulation product and method for forming the insulation product that may eliminate oven block changes and the need for machining or hand-tooling shiplap edges, and also allowing for reduced thickness of the insulation product while maintaining or increasing R-values.

### SUMMARY OF THE INVENTION

According to one exemplary embodiment, a duct board product is disclosed comprising a fibrous duct board having at least one set of opposing edges, a second board of insulating material having at least one set of opposing edges, and an adhesive material. The fibrous duct board is laminated to the second board of insulating material by the adhesive material. At least one edge of one set of opposing edges of the fibrous duct board is offset from at least one respective edge of one set of opposing edges of the second board of insulating material to form at least one shiplap edge.

According to another aspect, a method of fabricating a duct board product is disclosed comprising providing a fibrous duct board having at least one set of opposing edges, positioning a second board of insulating material having at least one set of opposing edges on the fibrous duct board such that at least one edge of one set of opposing edges of each of the fibrous duct board and second board are offset from one another to form at least one shiplap edge, and adhering the second board of insulating material to the fibrous duct board.

According to a further aspect, a duct board product is described comprising a fibrous duct board including resin bonded glass fibers, a second board of insulating material, and an adhesive material which laminates the fibrous duct board to the second board of insulating material. The fibrous duct board and second board of insulating material each include a first and second longitudinal opposing edge and a first and second transverse opposing edge. The first longitudinal opposing edges of the fibrous duct board and second board are offset from one another to form a female shiplap edge. The second longitudinal opposing edge of the fibrous duct board and second board form a butt edge of the duct board product. The first transverse opposing edge of the fibrous duct board and second board are offset from one another to form a female shiplap edge. The second transverse opposing edge of the fibrous duct board and second board are offset from one another to form a male shiplap edge.

### BRIEF SUMMARY OF THE SEVERAL VIEWS OF THE DRAWINGS

FIG. 1 is an elevated end view of an exemplary duct board.

FIG. 2 is an isometric view of the exemplary duct board of FIG. 1.

FIG. 3A is an isometric view of an exemplary duct board.

FIG. 3B is a cross-sectional view of the exemplary duct board of FIG. 3A folded into an exemplary duct section.

FIG. 3C is an isometric view of the duct section of FIG. 3B.

### DETAILED DESCRIPTION OF THE INVENTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

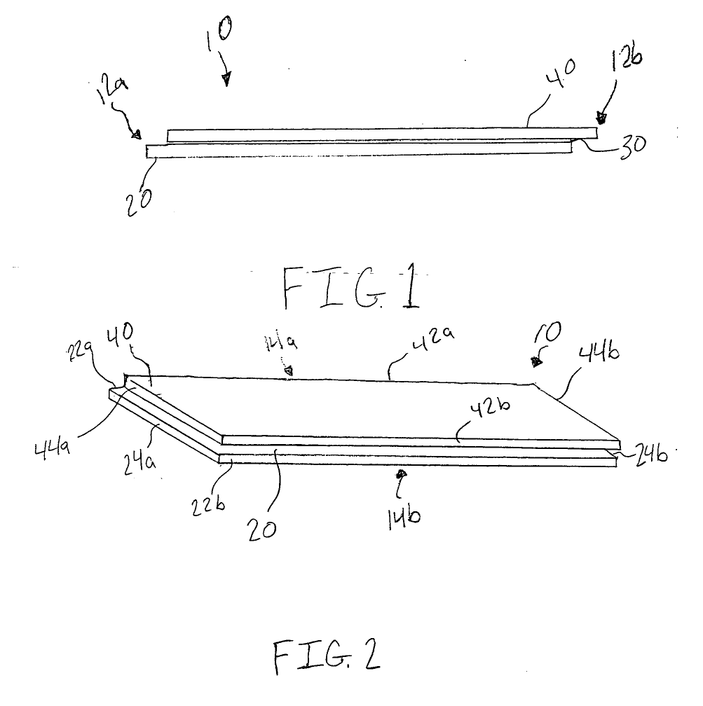

Referring to FIGS. 1 and 2, a duct board 10 is shown comprising a fibrous duct board layer 20, an adhesive material 30, and a second insulating board layer 40.

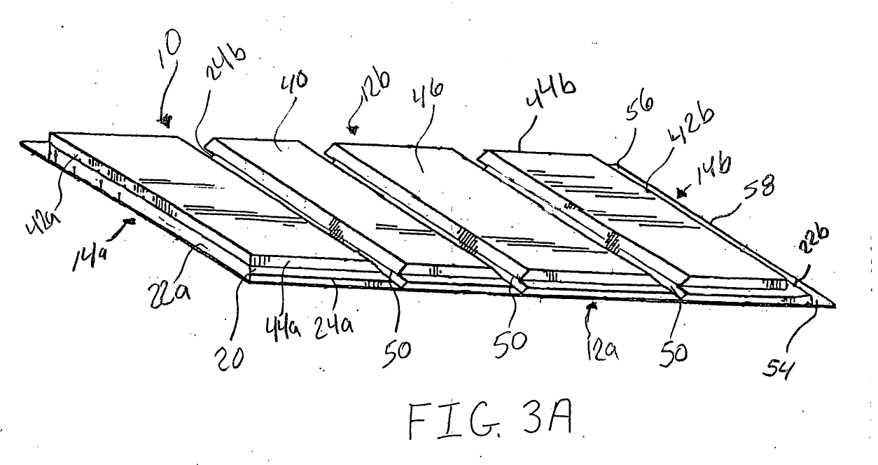

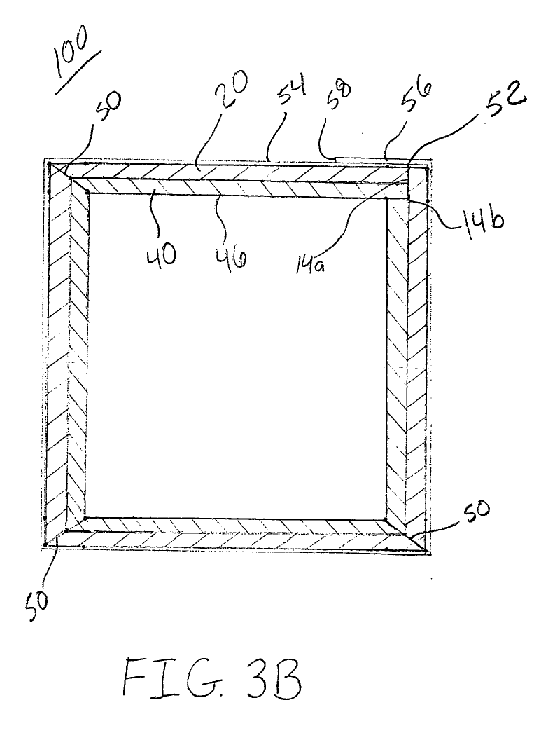

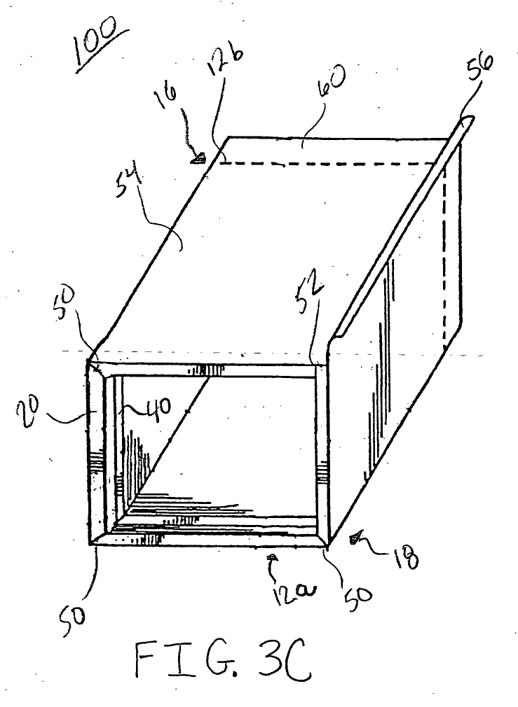

The fibrous duct board 20 has a pair of longitudinal opposing edges 22a, 22b and a pair of transverse opposing edges 24a, 24b. Preferably, duct board 20 also includes a facing material (see FIGS. 3A-C) such as a metal foil or a reinforced foil laminate (e.g., foil/scrim/kraft (FSK)) which acts as a finish and an air barrier/vapor retarder. The fibrous duct board layer 20 is preferably the base, or external, board layer when the duct board 10 is folded (as shown in FIGS. 3B and 3C) into a duct section.

The fibrous duct board layer 20 is preferably formed of resin bonded glass fibers, but may be formed of other inorganic or mineral fibers including rock wool fibers, slag fibers, and basalt fibers, or organic fibers, such as polyester, polypropylene or other polymeric fibers. The fibrous duct board layer 20 may vary in thickness, but preferably is 1 inch or 1½ inch, or within a range of thicknesses less than 1½ inch. However, thicknesses of greater than 1½ inch, such as 2 inch, are also contemplated. The fibrous duct board layer comprising glass fibers may be generated by conventional forming techniques such as a rotating glass fiberizer. In such technique, the glass fibers, following formation at the fiberizer, are collected on a takeaway conveyor, compressed to some extent, and directed toward an oven for curing the resin compound, which serves as the binder for the fibers to enable them to be formed into a self sustaining shape.

The adhesive material 30 may be any adhesive suitable for adhering together the fibrous duct board 20 and the second insulating board layer 40. Such adhesive material may be, for example, a hot melt glue or a water-based adhesive, or any other type of adhesive commonly used for adhering facing materials to insulation board. Preferably the adhesive is pliable enough to be readily cut by a hand tool or grooving machine. The adhesive material 30 may be applied as a substantially continuous coating between the two board layers 20, 40, or alternatively may be applied in strips or dots, for example.

The second insulating board layer 40 has a pair of longitudinal opposing edges 42a, 42b and a pair of transverse opposing edges 44a, 44b. The second insulating board layer 40 is preferably the top, or internal, board layer when the duct board 10 is folded (as shown in FIGS. 3B and 3C) into a duct section.

The second insulating board layer 40 may be comprised of the same material as the fibrous duct board layer 20, e.g., formed of resin bonded glass fibers. For example, both the fibrous duct board layer 20 and the second insulating board layer 40 may be fiberglass duct board. In one preferred embodiment, the layers 20, 40 are both 1 inch fiberglass duct board.

Alternatively, the second insulating board layer 40 may be comprised of a material different from the fibrous duct board layer 20. In one preferred embodiment, the second insulating board layer is comprised of a material having a higher R-value than the fibrous duct board layer 20. These materials may include foam, such as polystyrene (Styrofoam™), polyurethane and polyisocyanurate foams, or other insulating materials, which are preferably substantially rigid. In one preferred embodiment, the second insulating board layer 40 is comprised of Styrofoam™ and the fibrous duct board layer 20 is comprised of fiberglass duct board. The lamination of a higher R-value material to a base layer of fiberglass duct board allows the total thickness of the duct board 10 to be reduced while still maintaining a desired R-value. In a preferred embodiment, the total thickness of the duct board 10 does not exceed approximately 2 inches.

As shown in FIGS. 1 and 2, the second insulating board layer 40 is laminated to the fibrous duct board layer 20 in an offset manner, such that transverse edge 44b of second insulating board layer 40 extends beyond transverse edge 24b of fibrous duct board layer 20, and transverse edge 24a of fibrous duct board layer 20 extends beyond transverse edge 44a of second insulating board layer 40. Thus one transverse edge 12a of duct board 10 is formed into a transverse female shiplap edge and the opposing transverse edge 12b of duct board 10 is formed into a transverse male shiplap edge. Referring to FIG. 3C, when the duct board 10 is folded at the grooves 50 to form a duct section, a first end 16 of duct section 100, having a male shiplap edge 12b, can be mated with a second duct section (not shown) having a female shiplap edge to form a tight, sealed connection at the intersection of the two duct sections (the dashed line in FIG. 3C indicates the transverse edge 12b of duct board 10). A second end 18 of duct section 100, having a female shiplap edge 12a, can be mated with a third duct section (not shown) having a male shiplap edge to again form a tight, sealed connection at the intersection of the two duct sections. In a preferred embodiment, the first, second and third duct sections are all identically configured, and oriented in the same direction.

Preferably the second insulating board layer 40 is positioned on and laminated to the fibrous duct board layer 20 in an offset manner such that longitudinal edge 22b of fibrous duct board layer 20 extends beyond longitudinal edge 42b of second insulating board layer 20. Longitudinal edge 42a of second insulating board layer 40 and longitudinal edge 22a of fibrous duct board layer 20 are preferably not offset, i.e., they are even (coplanar) with one another. (Alternatively, longitudinal edge 42a of second insulating board layer 40 and longitudinal edge 22a of fibrous duct board layer 20 may be formed into a male shiplap edge. In such case, the duct board 10 would require an additional folding groove in the duct board 10 to achieve a mating between the male and female shiplap edges.) Accordingly, one longitudinal edge 14b of duct board 10 is formed into a longitudinal female shiplap edge, and the opposing longitudinal edge 14a of duct board 10 is formed into a longitudinal butt edge. As shown best in FIG. 3B, when the duct board 10 is folded at the grooves 50 to form a duct section 100, the longitudinal butt edge 14a and longitudinal female shiplap edge 14b are mated to form a tight, sealed connection at the duct joint 52.

Although shown in FIGS. 1, 2 and 3A as having at least one shiplap edge on both the longitudinal and transverse edges of the duct board, the duct board 10 may be formed such that only one or both of the longitudinal edges 14a, 14b form a shiplap edge, or that only the transverse edges 12a, 12b form a shiplap edge.

It should also be understood that although FIGS. 3B-3C illustrate an exemplary embodiment of a duct section which is square or rectangular, duct sections may also be circular or other multi-sided sections without departing from the scope of the present invention.

According to another aspect of the present invention, a method is described for fabricating a duct board comprising providing a fibrous duct board layer having two sets of opposing edges and adhering a second insulating board layer having two sets of opposing edges to the fibrous duct board layer such that at least one edge of the fibrous duct board layer is offset from at least one corresponding edge of the second insulating board layer to form at least one male and/or female shiplap edge. This method may be performed as part of an in-line process, which begins with the formation of the fibrous duct board layer in a curing oven, or may be performed off-line. Advantageously, the fibrous duct board layer (or layers, where the second insulating board layer is also a fibrous duct board layer) of the exemplary duct board can be formed in the same sizes and shapes as prior art duct boards (e.g., 1 inch or 1½ inch thicknesses), and thus does not require a modification or change of equipment to form the fibrous duct board layer. Further, unlike with current methods involving the molding of the shiplap edges in the curing oven, the method of fabricating the duct board described herein may eliminate the need for oven block changes and thus reduce operating costs.

As stated above, fibrous duct board layer 20, and therefore, duct section 100, may include a facing material 54 such as a metal foil or a reinforced foil laminate, e.g. FSK, which acts as a finish and an air barrier/vapor retarder. Preferably, the facing is applied to the fibrous duct board layer 20 in an in-line process once the fibrous duct board layer 20 has exited from the curing oven. The second insulating board layer 40 may be adhered to the fibrous duct board layer 20 before, simultaneously with or after application of the facing 54 to the fibrous duct board layer 20. Preferably, the facing material 54 is wider than the fibrous duct board layer 20 to include a first stapling or taping flap 56 along a longitudinal edge 58. The facing material 54 may also be longer than the fibrous duct board layer 20 to include a second stapling or taping flap 60 on one or both ends 16, 18 of the duct section 100 for facilitating a seal with adjacent duct sections (stapling flap 60 shown only on end 16; see FIG. 3C).

Referring again to FIGS. 3A-C, duct board 10 is shown with grooves 50 and facing 54 prior to and after being formed into duct section 100. As shown in FIG. 3A, after the lamination of the second insulating board layer 40 onto the fibrous duct board layer 20, a series of grooves 50 are cut, or otherwise formed, using hand tools or grooving machines, into duct board 10 from the top surface 46 of second insulating board layer 40 and extending into fibrous duct board layer 20 to allow the folding of the board into duct section 100. Once folded into duct section 100, the longitudinal female shiplap edge 14b is sealingly mated with longitudinal butt edge 14a. Also, preferably, ends 16, 18 of duct section 100 are formed into male and female shiplap edges 12a, 12b, respectively, for sealingly mating with corresponding male and female shiplap edges on adjacent duct sections.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A duct board product comprising:
a fibrous duct board having at least one set of opposing edges,
a second board of insulating material having at least one set of opposing edges, and
an adhesive material which laminates the fibrous duct board to the second board of insulating material,
wherein at least one edge of one set of opposing edges of the fibrous duct board is offset from at least one respective edge of one set of opposing edges of the second board of insulating material to form at least one shiplap edge.

2. The duct board product of claim 1,wherein the second board of insulating material comprises foam.

3. The duct board product of claim 1, wherein the foam comprises polystyrene, polyurethane or polyisocyanurate.

4. The duct board product of claim 1, wherein the second board of insulating material comprises a second fibrous duct board.

5. The duct board product of claim 1, wherein the fibrous duct board comprises glass fibers.

6. The duct board product of claim 1, wherein the adhesive material is a hot melt glue.

7. The duct board product of claim 1, wherein the adhesive material is a water-based adhesive.

8. The duct board product of claim 1, wherein the fibrous duct board and second board of insulating material each include a first and second longitudinal opposing edge, and wherein the first longitudinal opposing edges of the fibrous duct board and second board are offset from one another to form a female shiplap edge, and wherein the second longitudinal opposing edges of the fibrous duct board and second board form a butt edge of the duct board product.

9. The duct board product of claim 1, wherein the fibrous duct board and second board of insulating material each include a first and second transverse opposing edge, and wherein the first transverse opposing edges of the fibrous duct board and second board are offset from one another to form a female shiplap edge, and wherein the second transverse opposing edges of the fibrous duct board and second board are offset from one another to form a male shiplap edge.

10. The duct board product of claim 1, wherein the fibrous duct board comprises glass fibers and the second board comprises glass fibers, and wherein the fibrous duct board and second board have a thickness of approximately 1 inch.

11. The duct board product of claim 1, wherein the fibrous duct board comprises of glass fibers and the second board comprises a rigid foam material, and wherein the fibrous duct board and second board have a thickness of approximately 1 inch.

12. The duct board product of claim 1, wherein the total thickness of the duct board product does not exceed approximately 2 inches.

13. The duct board product of claim 1, wherein the duct board product has a total thickness of less than 2 inches and has an R-value of at least 8.0 BTU/h·ft²·F at 75°.

14. A method of fabricating a duct board product comprising:
providing a fibrous duct board having at least one set of opposing edges,
positioning a second board of insulating material having at least one set of opposing edges on the fibrous duct board such that at least one edge of one set of opposing edges of each of the fibrous duct board and second board are offset from one another to form at least one shiplap edge, and
adhering the second board of insulating material to the fibrous duct board.

15. The method of claim 10, further comprising forming a series of grooves in the duct board product and folding the duct board product to form a duct section.

16. A duct board product comprising:
a fibrous duct board comprising resin bonded glass fibers and having a first and second longitudinal opposing edge and a first and second transverse opposing edge,
a second board of insulating material having a first and second longitudinal opposing edge and a first and second transverse opposing edge, and
an adhesive material which laminates the fibrous duct board to the second board of insulating material,
wherein the first longitudinal opposing edges of the fibrous duct board and second board are offset from one another to form a female shiplap edge, and wherein the second longitudinal opposing edges of the fibrous duct board and second board form a butt edge of the duct board product, and
wherein the first transverse opposing edges of the fibrous duct board and second board are offset from one another to form a female shiplap edge, and wherein the second transverse opposing edges of the fibrous duct board and second board are offset from one another to form a male shiplap edge.

17. The duct board product of claim 16, wherein the second board of insulating material is comprised of resin bonded glass fibers

18. The duct board product of claim 16, wherein the second board of insulating material is comprised of a rigid foam material.

19. The duct board product of claim 16, wherein the total thickness of the duct board product does not exceed 2 inches.
